(19) United States
(12) Patent Application Publication
(10) Pub. No.: US 2005/0132351 A1
(43) Pub. Date: Jun. 16, 2005

(54) Updating electronic device software employing rollback

(76) Inventors: Roderick K. Randall, Hopkinton, MA (US); Harri Okkonen, Dana Point, CA (US); Bindu Rama Rao, Laguna Niguel, CA (US)

Correspondence Address: MCANDREWS HELD & MALLOY, LTD, 500 WEST MADISON STREET, SUITE 3400, CHICAGO, IL, 60661, US

(21) Appl. No.: 10/955,021

(22) Filed: Sep. 30, 2004

Related U.S. Application Data
(60) Provisional application No. 60/529,367, filed on Dec. 12, 2003.

(51) Int. Cl. G06F 9/44

(52) U.S. Cl. 717/168

(57) ABSTRACT

Disclosed herein is a network communicating with a plurality of mobile electronic devices. The network and the mobile electronic devices may support rollback of updated firmware/software from an updated version to a previous version. The previous version may be stored in non-volatile memory in the mobile electronic device. The non-volatile memory may be, for example, a NAND-type flash memory. In an embodiment according to the present invention, a backup zone of non-volatile memory may be employed to backup firmware/software to be updated in the mobile electronic device. An update agent may be provided to update firmware/software in the mobile electronic device. The update agent may include updating software stored in the mobile electronic device. In an embodiment according to the present invention, automatic rollback may be supported. In another embodiment according to the present invention, a user-initiated hard rollback may also be supported.

### CROSS-REFERENCE TO RELATED APPLICATIONS

The present application claims the benefit of U.S. Provisional Patent Application Ser. No. 60/529,367 entitled “MOBILE DEVICES CAPABLE OF UPDATING FIRMWARE OR SOFTWARE WITH ROLLBACK”, filed Dec. 12, 2003, the complete subject matter of which is hereby incorporated herein by reference in its entirety.

The present application also hereby incorporates herein by reference in its entirety, the complete subject matter of U.S. Provisional Patent Application 60/428,069, filed Nov. 11, 2002.

The present application also hereby incorporates herein by reference in its entirety, the complete subject matter of PCT Application having publication number WO 02/41147 A1 and PCT application number PCT/US01/44034, filed on Nov. 19, 2001.

The present application also hereby incorporates herein by reference in its entirety, the complete subject matter of U.S. Provisional Patent Application 60/249,606 filed on Nov. 17, 2000.

### FEDERALLY SPONSORED RESEARCH OR DEVELOPMENT

[Not Applicable]

### [MICROFICHE/COPYRIGHT REFERENCE]

[Not Applicable]

### BACKGROUND OF THE INVENTION

Electronic devices such as mobile phones and personal digital assistants (PDA's) often contain firmware and application software that are either provided by the manufacturers of the electronic devices, by telecommunication carriers, or by third parties. These firmware and application software often contain software bugs. New versions of the firmware and software are periodically released to fix the bugs, to introduce new features, or both.

Electronic devices, such as mobile handsets, access servers to retrieve update packages that are needed to update firmware and/or software. When thousands of mobile handsets simultaneously attempt to access the servers, some of them may not be able to get connected. There is a need for wireless networks to determine if individual mobile handsets can be updated. There is a need for wireless networks to facilitate downloading of update packages by mobile handsets.

Creating efficient and compact update packages for firmware/software updates is a big challenge. Managing update packages efficiently in a carrier network is also a great challenge. Managing the lifecycle of firmware and software in electronic devices, such as mobile handsets, is a complicated and important task.

Updating the updating software (update agent) in a wireless mobile electronic deice may be challenging. If the update is not installed and executed properly, the update agent may be rendered corrupted or inoperable. Collecting updates (update packages from a plurality of sources in a secure mode may be challenging. Providing the electronic devices with downloadable access to the collected update packages may employ complex management tasks.

Updating of firmware and/or software in electronic devices may be one-way, wherein it may be challenging to rollback to a previous version. Determining when a rollback is necessary may be important and complicated. Some of techniques may be technology specific. Mobile electronic devices may be constrained devices and it may not be possible to rollback to previous versions of firmware and/or software.

Further limitations and disadvantages of conventional and traditional approaches will become apparent to one of ordinary skill in the art through comparison of such systems with the present invention as set forth in the remainder of the present application with reference to the drawings.

### SUMMARY OF THE INVENTION

Aspects of the present invention may be found in a method of updating a mobile electronic device. The method may comprise storing a copy of one of firmware and software to be updated in the mobile electronic device, updating the one of firmware and software, determining whether the update was successful, and rolling back to an un-updated version of the one of firmware and software upon determining that the update was unsuccessful.

In an embodiment according to the present invention, the method may further comprise commencing normal operation upon determining that the update was successful.

In an embodiment according to the present invention, the method may further comprise deleting the stored one of firmware and software upon determining that the update was successful.

In an embodiment according to the present invention, the method may further comprise transmitting a rollback command to the mobile electronic device.

In an embodiment according to the present invention, the method may further comprise receiving a rollback command by the mobile electronic device and performing an autonomous, automatic rollback to the un-updated version of the one of firmware and software.

In an embodiment according to the present invention, the method may further comprise receiving a rollback command by the mobile electronic device and prompting an end-user to initiate rollback to the un-updated version of the one of firmware and software.

In an embodiment according to the present invention, the method may further comprise prompting an end-user to initiate rollback to the un-updated version of the one of firmware and software.

In an embodiment according to the present invention, determining whether the update was successful may be performed by one of the mobile electronic device and an associated mobile electronic device network component.

In an embodiment according to the present invention, updating the one of firmware and software may comprise executing at least one program instruction for converting a first version of the one of firmware and software to a second version of the one of firmware and software.

In an embodiment according to the present invention, storing a copy of one of firmware and software to be updated may comprise writing an un-updated version of the one of firmware and software to one of a non-volatile memory component, a NAND-type flash memory component, a NOR-type flash memory component, and a combination NAND/NOR-type flash memory component.

Aspects of the present invention may be found in a mobile electronic device adapted to rollback to an un-updated version of one of firmware and software after an update thereof. The mobile electronic device may comprise updating software adapted to perform an update upon the one of firmware and software, an update comprising at least one executable program instruction for converting a first version of the one of firmware and software to a second version of the one of firmware and software, and a memory location adapted to store the un-updated version of the one of firmware and software to be updated at least until the update is completed. In an embodiment according to the present invention, upon determining that the update was unsuccessful, the mobile electronic device may be adapted to reinstall and employ the un-updated version of the one of firmware and software.

In an embodiment according to the present invention, the memory location adapted to store the un-updated version of the one of firmware and software to be updated may comprise one of a non-volatile memory component, a NAND-type flash memory component, a NOR-type flash memory component, and a combination NAND/NOR-type flash memory component.

In an embodiment according to the present invention, the mobile electronic device may further comprise software adapted to manage memory resources in the mobile electronic device.

In an embodiment according to the present invention, the mobile electronic device may be adapted to commence normal operation upon determining that the update was successful.

In an embodiment according to the present invention, the mobile electronic device may be adapted to delete the un-updated version of one of firmware and software upon determining that the update was successful.

In an embodiment according to the present invention, the mobile electronic device may be adapted to prompt an end-user to initiate rollback to the un-updated version of the one of firmware and software.

In an embodiment according to the present invention, the mobile electronic device may be adapted to receive a rollback command and perform an autonomous, automatic rollback to the un-updated version of the one of firmware and software.

In an embodiment according to the present invention, the mobile electronic device may be adapted to receive a rollback command and prompt an end-user to initiate rollback to the un-updated version of the one of firmware and software.

In an embodiment according to the present invention, the mobile electronic device may be adapted to perform an autonomous, automatic rollback to the un-updated version of the one of firmware and software.

In an embodiment according to the present invention, he mobile electronic device may further comprise software adapted to determine whether the update was performed successfully.

Aspects of the present invention may be found in a method of updating a mobile electronic device. The method may comprise storing a copy of one of firmware and software to be updated in the mobile electronic device. The one of firmware and software and the stored copy may be compressed. The method may also comprise decompressing the one of firmware and software, updating the one of firmware and software, re-compressing the updated one of firmware and software, rebooting the mobile electronic device, and executing the updated one of firmware and software. The mobile electronic device may be adapted to rollback to the stored copy of the one of firmware and software.

In an embodiment according to the present invention, the method may further comprise rolling back to the stored copy of the one of firmware and software upon determining that the update was unsuccessful.

In an embodiment according to the present invention, the method may further comprise rolling back to the stored copy of the one of firmware and software upon determining that a limited-time trial period has expired.

In an embodiment according to the present invention, the method may further comprise rolling back to the stored copy of the one of firmware and software upon determining that service fees are not paid.

In an embodiment according to the present invention, the method may further comprise enabling an end-user to rollback to the stored copy of the one of firmware and software when dissatisfied with updated services provided by the updated one of firmware and software.

In an embodiment according to the present invention, the method may further comprise enabling one of a network component and a network administrator to command the mobile electronic device to rollback to the stored copy of the one of firmware and software by transmitting a rollback command to the mobile electronic device.

In an embodiment according to the present invention, updating the one of firmware and software may comprise executing at least one program instruction for converting a first version of the one of firmware and software to a second version of the one of firmware and software.

In an embodiment according to the present invention, storing a copy of one of firmware and software to be updated may comprise writing a compressed, un-updated version of the one of firmware and software to one of a non-volatile memory component, a NAND-type flash memory component, a NOR-type flash memory component, and a combination NAND/NOR-type flash memory component.

These and other advantages, aspects, and novel features of the present invention, as well as details of illustrated embodiments, thereof, will be more fully understood from the following description and drawings.

### BRIEF DESCRIPTION OF SEVERAL VIEWS OF THE DRAWINGS

FIG. 1 is a block-diagram illustrating a mobile electronic device network according to an embodiment of the present invention;

FIG. 1A is a block diagram illustrating a mobile electronic device according to an embodiment of the present invention;

FIG. 2 is a flow diagram illustrating a method of updating a mobile electronic device according to an embodiment of the present invention;

FIG. 3 is a flow diagram illustrating a method of performing an automatic software rollback in a mobile electronic device according to an embodiment of the present invention;

FIG. 4 is a flow diagram illustrating a method of performing an hard software rollback in a mobile electronic device according to an embodiment of the present invention;

FIG. 5 is a flow diagram illustrating a method of initiating a software rollback in a mobile electronic device according to an embodiment of the present invention;

FIG. 6 is a flow diagram illustrating a method of deleting backed up software after performing a software rollback in a mobile electronic device according to an embodiment of the present invention.

### DETAILED DESCRIPTION OF THE INVENTION

Aspects of the present invention may be found in a method of updating firmware/software components in electronic devices, such as for example, mobile handsets, cellular telephones, personal digital assistants, pagers, personal computers, etc. Aspects of the present invention may also be found in a network adapted to collect update packages from multiple sources and disseminate the update packages to a plurality of electronic devices.

In an embodiment according to the present invention, the electronic device updating software (update agent) may be updated. However, if the update is not received, installed, and executed properly, the update agent may be rendered corrupted or inoperable. In another embodiment according to the present invention, updates (update packages) may be collected from a plurality of sources in a secure manner. Aspects of the present invention may also be found in providing the wireless mobile electronic devices with downloadable access to the collected update packages.

In an embodiment according to the present invention, firmware may be considered to be software placed in a read-only memory device in an embedded system in an electronic device. Firmware may also comprise software necessary to boot, initialize, and run the embedded software.

In an embodiment according to the present invention, flash memory may be a memory resource re-programmable or writeable in the field, for example. Flash memory has many characteristics that make it distinct from other types of memory. Flash memory may also be used as read-only memory.

In an embodiment according to the present invention, a software/firmware version may be defined as identification information associated with a firmware image or software application. The identification information may be numeric, such as, for example, version 1, version 2, version 2.2, version 3a, etc., but may also be textually descriptive.

In an embodiment according to the present invention, an update package may be defined as a collection of data/meta-data and update/upgrade instructions that when bundled and delivered to an electronic device update agent are adapted to facilitate firmware/software updates in the electronic devices. The data/meta-data may include information associated with loading update(s)/upgrade(s) and verifying the contents of the update(s)/upgrade(s) and associated instructions. The update/upgrade instructions may comprise a set of executable instructions for converting from one version of electronic device firmware/software to another. The update/upgrade instructions may also comprise list of program changes facilitating migration from one version of electronic device firmware to another.

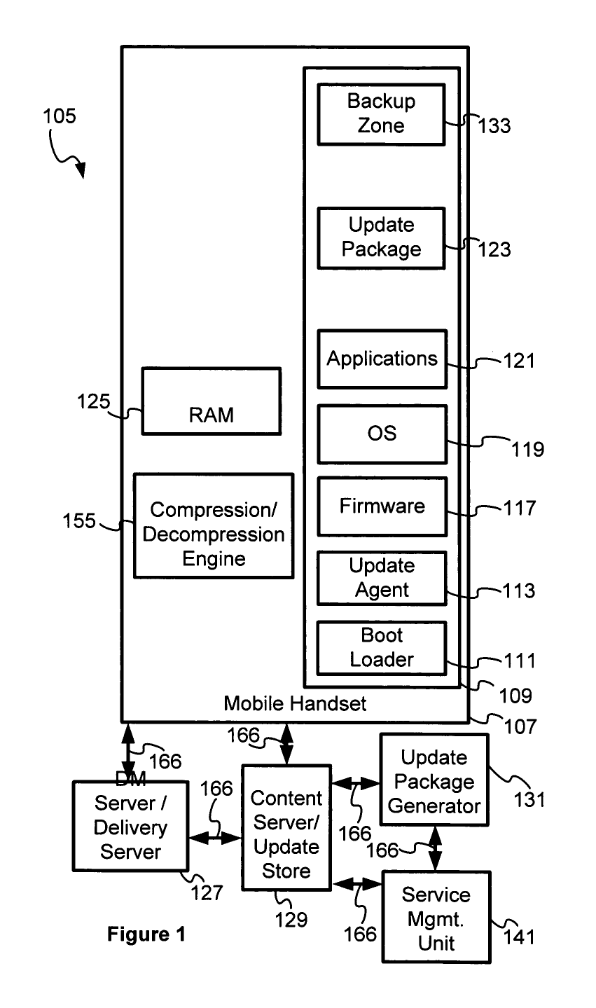

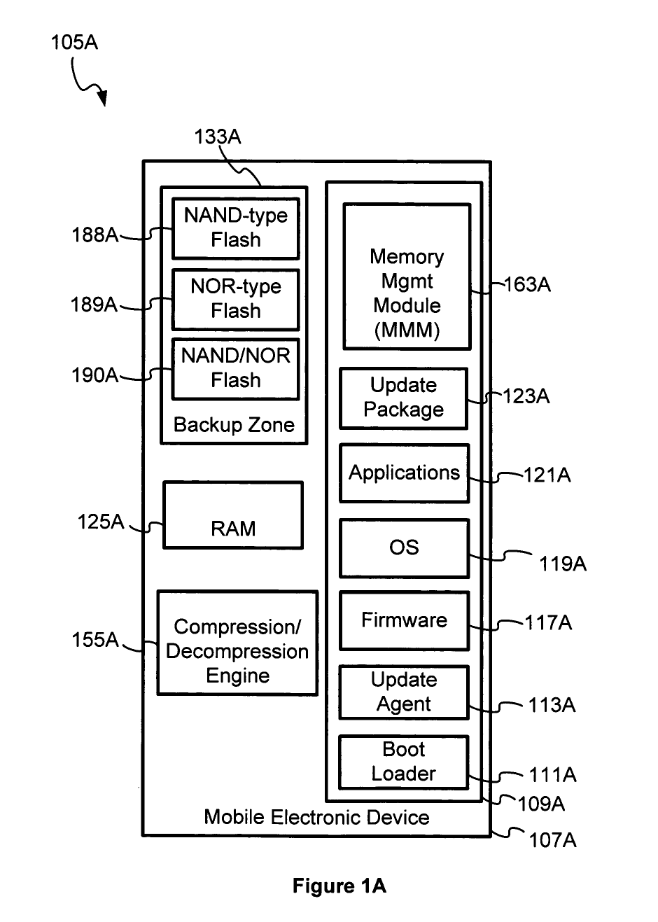

FIG. 1 is a block diagram illustrating a mobile electronic device network 105, according to an embodiment of the present invention, capable of updating a plurality of mobile electronic devices, such as for example, mobile handset 107. In an embodiment according to the present invention, the mobile electronic devices may be updated employing over-the-air (OTA) technology, for example.

In an embodiment according to the present invention, the mobile electronic devices may be capable of employing a backup memory zone/region 133 in non-volatile memory 109 to backup one of a firmware 117, an operating system component(s) 119, an update agent 113, a boot loader software 111, and/or software applications 121, for example, to be updated. The firmware/software components of the mobile electronic devices may be compressed in storage and decompressed for execution, for example, employing compression/decompression engine 155 in accordance with an embodiment of the present invention.

In an embodiment according to the present invention, an update may comprise an update package 123, for example. The update package 123 may comprise executable program instructions for converting a first version of firmware/software to a second/updated version of firmware/software. The update package 123 may be received in a compressed form, stored in a compressed form, decompressed into RAM 125 for execution, and re-compressed for subsequent storage. The mobile electronic devices may comprise a non-volatile memory (NVM) component 109 and a random access memory (RAM) component 125, for example. Firmware/software may be stored in compressed form in the NVM 109, decompressed by the compression/decompression engine 155 into RAM 125 for execution, and re-compressed back into the NVM 109 for subsequent storage.

In an embodiment according to the present invention, the mobile electronic device 107 may be communicatively coupled via a plurality of communications links 166 to a device management (DM) server/delivery server 127, a content server/update store module 129, an update package generator 131, and a service management unit 141, for example. Information transmitted from network components to the mobile electronic devices may be in compressed form, for example.

In an embodiment according to the present invention, mobile electronic devices, such as for example, mobile handset 107, may be capable of automatically detecting inoperative and/or corrupted firmware/software following an update operation of the firmware/software. In an embodiment according to the present invention, the mobile electronic device may also be capable of automatically initiating incorporation of and/or reversion to a backed-up (or previous, un-updated version) of firmware/software in stored in backup zone 133 of non-volatile memory 109, for example. In an embodiment according to the present invention, firmware/software to be updated may be backed up (i.e., a backup copy created and stored) in the backup zone 133 to provide rollback functionality.

In an embodiment according to the present invention, rollback functionality in a mobile electronic device may comprise the ability to rollback to a previous, operational version of firmware/software in a situation where an updated firmware/software version is determined to be corrupted, inoperative or otherwise faulty, for example.

In an embodiment according to the present invention, the update agent 113 may perform the update (i.e., execute the program instructions converting the firmware/software from a first version to a second version) of the firmware/software. In an embodiment according to the present invention, following updating of firmware/software, the mobile electronic device may determine that the update is unsuccessful. The electronic device may automatically/autonomously revert back or rollback to the previous (i.e., un-updated) version of the firmware/software in order to recover from the unsuccessful update. The mobile electronic device may be adapted to reinstall the previous version of firmware/software by performing a rollback operation. In an embodiment according to the present invention, the mobile electronic device may employ (i.e., make operative, reinstall) the previous, un-updated version of firmware/software stored in the backup zone 133.

In an embodiment according to the present invention, the mobile electronic device may also delete/erase/overwrite the updated (but faulty or corrupt version) of firmware/software. In an embodiment according to the present invention, the mobile electronic device may also free-up (e.g., make available for writing to) memory regions where the updated (but faulty or corrupt version) of firmware/software is stored. In an embodiment according to the present invention, the mobile electronic device may also overwrite the updated (but faulty or corrupt version) of firmware/software with the previous (i.e., un-updated) version of firmware/software. In an embodiment according to the present invention, a mobile electronic device, such as for example, mobile handset 107, may retain the updated firmware/software for a particular duration of time. In an embodiment according to the present invention, the mobile electronic device may perform the update a number of times upon determining that each update attempt is unsuccessful, for example.

In an embodiment according to the present invention, the update may be performed successfully, but the changes provided by the update may be unsatisfactory to an end-user. For example, a mobile handset may be updated with a plurality of ringtones, for example. The end-user may be unsatisfied with the updated ringtones and may elect to return to the previous set of ringtones. The end-user may be permitted to cause the mobile handset to rollback/revert to the previous set of ringtones.

In another embodiment according to the present invention, a mobile service provider may offer a trial version of electronic device services. For example, a mobile handset may be updated and provided with a plurality of new ringtones, for example. The end-user may be permitted to use the ringtones for a limited time, wherein after expiration of the limited time offer, the end-user may be required to pay to keep the ringtones. If the end-user chooses not to pay for the ringtones, for example, the mobile handset may be adapted to automatically/autonomously rollback/revert to the previous version of ringtones, for example. Ringtones are discussed herein for purposes of example. The present invention is not limited to ringtones, but rather includes any firmware/software-implemented services loadable and executable by the mobile electronic devices, for example.

In an embodiment according to the present invention, the mobile electronic device may employ a boot loader 111 to perform a bootstrap of the mobile electronic device and to reference and reinstall the backed-up (i.e., previous or un-updated version) of firmware/software available in the backup zone 133. For example, a reference variable in boot loader 111 may be used to access the updated firmware/software and/or the previous, un-updated version of the firmware/software stored in the backup zone 133, based upon a determination of the success or failure of the update performed.

In an embodiment according to the present invention, the mobile electronic device, such as for example, mobile handset 107, may support automatic/autonomous rollback of firmware/software from an updated version (that may be corrupted, undesirable, and/or expired) to a previous, un-updated version copied/stored to the backup zone 133 prior to initiating update activity. In an embodiment according to the present invention, the mobile electronic device, such as for example, mobile handset 107, may also support a hard rollback of firmware/software to an older version. A hard rollback may comprise an end-user initiated rollback to a previous version of firmware/software.

In an embodiment according to the present invention, an electronic device end-user may activate/initiate a hard rollback by pressing down on a power key, some other key, or even a combination of keys, for some duration of time, for example, 6 seconds. In an embodiment according to the present invention, the DM server 127 may be capable of initiating a rollback of the firmware/software from an updated version to a previous/un-updated version, for example, a version copied/saved in the backup zone 133 in NVM 109. In an embodiment according to the present invention, a rollback may be initiated from a network device and/or a network administrator from a location remote from the mobile electronic device.

In an embodiment according to the present invention, a mobile device network administrator may be enabled to initiate a rollback of at least one mobile electronic device via communication transmitted from the electronic device network to the at least one mobile electronic device. In an embodiment according to the present invention, communication between the network and the at least one mobile electronic device may be via a wire or wireless connection, for example. In an embodiment according to the present invention, an end-user of the mobile electronic device may be able to initiate rollback to a previous version of firmware/software, for example.

In an embodiment according to the present invention, mobile electronic device network 105 may be adapted to facilitate rollback from an updated version of firmware/software to a previous un-updated version of firmware/software. In an embodiment according to the present invention, mobile electronic device network 105 may be adapted to prompt an end-user of the mobile electronic device to pay for a trial service or to initiate a firmware/software rollback.

In an embodiment according to the present invention, the mobile electronic device may be adapted to autonomously detect update failure and prompt an end-user of the mobile electronic device to initiate a firmware/software rollback. The previous, un-updated version may be stored in NVM 109, for example. In an embodiment according to the present invention, the backup zone 133 of NVM 109 may be employed to backup firmware/software to be updated by the update agent 113, for example. In an embodiment according to the present invention, automatic rollback may be supported after expiration of a time limit, for example. In an embodiment according to the present invention, an electronic device user-initiated and/or network administrator-initiated rollback may also be supported.

FIG. 1A is a block diagram 105A illustrating a mobile electronic device 107A according to an embodiment of the present invention. In an embodiment according to the present invention, the mobile electronic device 107A may comprise a non-volatile memory (NVM) component 109A, a random access memory (RAM) component 125A, and a backup memory zone 133A, for example.

In an embodiment according to the present invention, NVM 109A may comprise a boot loader software module 111A, an update agent (updating software) 113A, a firmware 117A, an operating system (OS) 119A, an update package 123A, and software applications 121A, for example. Firmware/software in the mobile electronic device may be compressed in storage, decompressed for execution and updating, and re-compressed for subsequent storage by compression/decompression engine 155A, for example. In an embodiment according to the present invention, NVM 109A may also comprise a memory management module (MMM) 163A. In an embodiment according to the present invention, MMM 163A may be adapted to organize, monitor, and supervise memory resources of the mobile electronic device, for example. In an embodiment according to the present invention, MMM 163A may be adapted to facilitate firmware software rollbacks, for example.

In an embodiment according to the present invention, the backup memory zone 133A may comprise an independent non-volatile memory device, for example. In an embodiment according to the present invention, the backup memory zone 133A may also be a sub-portion of NVM 109A, for example.

In an embodiment according to the present invention, an exemplary backup memory zone 133A may comprise at least one of a NAND-type flash memory portion 188A, a NOR-type memory portion 189A, and/or a combination NAND/NOR-type memory portion 190A, for example. Although backup zone 133A is shown in FIG. 1A employing NAND-type flash memory portion 188A, NOR-type memory portion 189A, and a combination NAND/NOR-type memory portion 190A, any combination of flash memory portions and any number of the flash memory portion types may be employed depending upon the specifications of the mobile electronic device to be used.

TABLE 1
Comparison of NOR-type and NAND-type flash memory.

| | NOR-type | NAND-type |
|---|---|---|
| Interface | Bus | Input/Output (I/O) |
| Cell size | Large | Small |
| Cell Cost | High | Low |
| Read Time | Fast | Slow |
| Program Time | Fast | Slow |
| Single Byte | | |
| Program Time | Slow | Fast |
| Multi-Byte | | |
| Erase Time | Slow | Fast |
| Power | Slow | Low, but requires additional RAM |
| Consumption | | |
| Can Execute Code | Yes | No, but may execute a small loader |
| | | out of a first page |
| Bit Twiddling | Nearly | 1-3 times, also known as “partial |
| | Unrestricted | page program restriction” |
| Bad Blocks at | No | Allowed |
| Ship Time | | |

Table 1 above illustrates differences and similarities between NOR-type flash memory and NAND-type flash memory, non-volatile memory types adapted to be employed in accordance with an embodiment of the present invention.

In an embodiment according to the present invention, read time for NAND-type flash memory, such as for example, NAND-type flash memory portion 188A illustrated in FIG. 1A, may be slow, however, write time (multi-byte) may be fast, for example. In an embodiment according to the present invention, it may be possible to copy firmware/software from existing blocks of NAND-type flash memory, such as for example, NAND-type flash memory portion 188A illustrated in FIG. 1A, to a back-up set of blocks creating a back-up copy of the firmware/software, for example. Firmware/software stored in the flash memory portions may be stored in compressed form.

In an embodiment according to the present invention, blocks of existing firmware/software may be copied (e.g., decompressed) to RAM 125A and may be backed up (e.g., compressed) into a designated available backup zone 133A, such as for example, the backup zone 133A illustrated in FIG. 1A, and in free NAND-type flash memory, such as for example, NAND-type flash memory portion 188A illustrated in FIG. 1A.

In an embodiment according to the present invention, after a successful update has been performed on firmware/software, the backup zone 133A may be erased/deleted/overwritten, for example. In an embodiment according to the present invention, erasing a NAND-type flash memory, such as for example, NAND-type flash memory portion 188A illustrated in FIG. 1A may be efficiently performed.

In an embodiment according to the present invention, determining when a rollback is to be performed may involve end-user intervention, network administrator intervention, a network monitoring device intervention, or may be autonomous, for example. End-user intervention may comprise the end-user becoming dissatisfied with a particular service (e.g., a distinctive ringtone) and may select to rollback to a previous service (e.g., more desirable ringtone), for example.

In an embodiment according to the present invention, NAND-type flash memory, such as for example, NAND-type flash memory portion 188A illustrated in FIG. 1A may comprise a disk on a chip (DiskOnChip) configuration, for example. In an embodiment according to the present invention, the mobile electronic device 107A may be adapted to employ adaptive logic (such as for example, glue logic) as a drop in replacement for NOR-type flash memory chips, such as for example, NOR-type flash memory portion 189A illustrated in FIG. 1A.

In an embodiment according to the present invention, adaptive logic may provide direct memory access to a small address window, which may contain a boot loader stub, for example, which may load boot code from a NAND-type flash memory, such as for example, NAND-type flash memory portion 188A illustrated in FIG. 1A. In an embodiment according to the present invention, adaptive logic may also comprise control registers for static NAND-type flash memory chip control lines and an error correction code (ECC) generator hardware device, for example.

In an embodiment according to the present invention, a NAND-type flash memory, such as for example, NAND-type flash memory portion 188A illustrated in FIG. 1A, may comprise pages. In an embodiment according to the present invention, a page may comprise 256/512 byte data and 8/16 byte spare/set-aside area, for example. In an embodiment according to the present invention, a spare/set-aside area may be used to store error correction code (ECC) and data, bad block information, and file system dependent data, for example.

In an embodiment according to the present invention, one block may comprise “n” pages, for example. In an embodiment according to the present invention, 16-kilobyte blocks may be employed, for example. In an embodiment according to the present invention, read/write access to data may be made on a per-page basis, for example. In an embodiment according to the present invention, erasing may be performed on a per-block basis, for example.

In an embodiment according to the present invention, the electronic device may be adapted to boot from a NAND-type flash memory chip, such as for example, NAND-type flash memory portion 188A illustrated in FIG. 1A. In an embodiment according to the present invention, adaptive logic may be employed to provide access to memory during bootstrapping, for example.

In an embodiment according to the present invention, a 1-megabyte (MB) NOR-type flash memory may comprise boot code and a compressed kernel image, for example. In an embodiment according to the present invention, NAND-type flash memory, such as for example, NAND-type flash memory portion 188A illustrated in FIG. 1A may be employed to store a root file system, for example.

In an embodiment according to the present invention, a page of NAND-type flash memory, such as for example, NAND-type flash memory portion 188A illustrated in FIG. 1A, may be written to 1-3 consecutive times, wherein thereafter the memory may be erased. In an embodiment according to the present invention, the spare area may also be written to 1-3 consecutive times, wherein thereafter the memory may be erased. In an embodiment according to the present invention, the file system may be provided with a write buffer, for example, adapted to contain less than a page of data.

In an embodiment according to the present invention, a firmware/software update may be performed in a fault-tolerant bank-by-bank update, for example, as employed in NOR-type flash memory, such as for example, NOR-type flash memory portion 189A illustrated in FIG. 1A.

In an embodiment according to the present invention, in order to facilitate recovery, for example, if the updated firmware/software is inoperative, undesirable, or expired, a backup zone 133A comprising a NAND-type flash memory, such as for example, NAND-type flash memory portion 188A illustrated in FIG. 1A, may be employed to back-up the previous, un-updated firmware/software prior to performing the firmware/software update, for example.

In an embodiment according to the present invention, the mobile electronic device 107A may be adapted to determine whether the update performed upon the firmware/software is successful/failed, wherein upon determining that the update failed, the mobile electronic device 107A may be adapted to automatically/autonomously rollback to the previous, un-updated version of firmware/software.

In an embodiment according to the present invention, an end-user may be enabled to force a hard rollback by holding down a button(s) for a particular duration of time (for example, six (6) seconds). In an embodiment according to the present invention, an end-user may be enabled to force a hard rollback if an automatic rollback fails, for example. In an embodiment according to the present invention, an end-user may be enabled to force a hard rollback if the end-user is unsatisfied with the services provided by the firmware/software update, or if the end-user does not intend to pay for a particular service, for example.

In an embodiment according to the present invention, a network administrator may be enabled to force a rollback upon detecting that an automatic rollback has failed, for example. In an embodiment according to the present invention, a network administrator may be enabled to force a rollback upon detecting that an end-user initiated hard rollback has not been performed. In an embodiment according to the present invention, a network administrator may be enabled to communicate a request for the mobile electronic device 107A to initiate and automatic rollback, for example. The network administrator may also be enabled to cause a rollback upon determining that services fees are not paid.

In an embodiment according to the present invention, firmware/software stored in the backup zone 133A may be stored for a particular duration of time, for example, until an updated service is paid for. In an embodiment according to the present invention, firmware/software stored in the backup zone 133A may be deleted after expiration of a particular duration of time.

In an embodiment according to the present invention, providing the mobile electronic device 107A with rollback functionality may ensure that an operational firmware/software is available, thus preventing catastrophic device failure. Rollback functionality may also ensure that an end-user is provided a choice to review the updated service(s) and select to keep them or return to previous services.

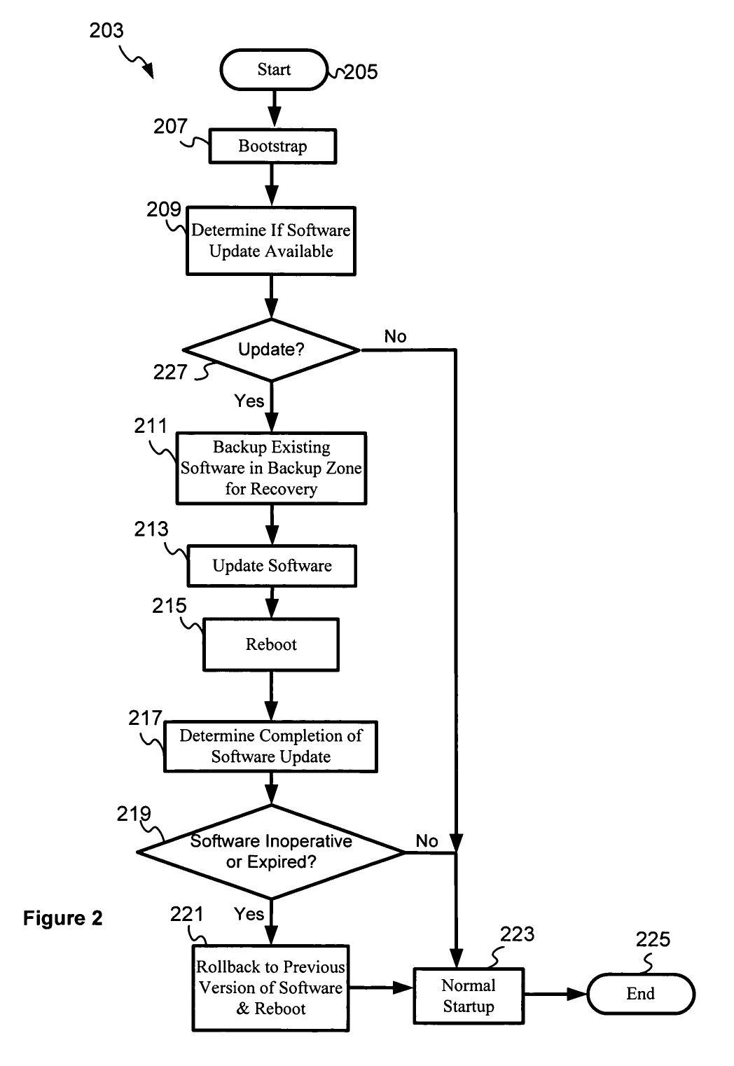

FIG. 2 is a flow diagram 203 illustrating a method of updating a mobile electronic device, such as for example, mobile electronic device 107A illustrated in FIG. 1A, according to an embodiment of the present invention.

In an embodiment according to the present invention, the method may begin at start block 205, for example. In an embodiment according to the present invention, the mobile electronic device, such as for example, mobile electronic device 107A illustrated in FIG. 1A, may be powered up, for example, and a boot loader, such as for example boot loader 111A illustrated in FIG. 1A, may initiate bootstrap operations (block 207). In an embodiment according to the present invention, a bootstrap code may be adapted to determine whether to update firmware/software (block 209) and whether an update is available, for example. In an embodiment according to the present invention, the electronic device, such as for example, mobile electronic device 107A illustrated in FIG. 1A, may proceed to a normal startup or perform an update of firmware/software based upon the previous determination (decision block 227).

In an embodiment according to the present invention, if it is determined that a firmware/software update is unnecessary/unavailable, then normal startup may be invoked (block 223). In an embodiment according to the present invention, if it is determined that a firmware/software update is necessary/available, firmware/software to be updated may be backed up (copied and stored) in a backup zone, such as for example, backup zone 133A illustrated in FIG. 1A, for subsequent recovery, for example (block 211).

In an embodiment according to the present invention, the firmware/software to be updated may be decompressed out of storage into RAM and updated (e.g., converted from a first version to a second version by executing a plurality of program instructions) by an update agent, such as for example, update agent 113A illustrated in FIG. 1A, (block 213). In an embodiment according to the present invention, the mobile electronic device, such as for example, mobile electronic device 107A illustrated in FIG. 1A, may be rebooted after being updated, for example, (block 215).

In an embodiment according to the present invention, the mobile electronic device may determine the completion/success/failure of the firmware/software update (block 217). In an embodiment according to the present invention, the completion/success/failure determination may be made automatically, or may be determined, for example, via communication with a network device, such as for example, DM server 127 illustrated in FIG. 1.

In an embodiment according to the present invention, a determination may be made as to whether the updated firmware/software is inoperative, corrupted, or expired, for example (block 219). In an embodiment according to the present invention, a rollback to an older/previous, un-updated version of the firmware/software may be initiated, wherein the electronic device, such as for example, mobile electronic device 107A illustrated in FIG. 1A, may also be rebooted (block 221). In an embodiment according to the present invention, normal startup of the mobile electronic device, such as for example, mobile electronic device 107A illustrated in FIG. 1A may be initiated (block 223). The method may terminate at end block 225, for example.

In an embodiment according to the present invention, if it is determined that the firmware/software is operative, and thus that the update is successfully completed, (block 219), then normal startup of the mobile electronic device, such as for example, mobile electronic device 107A illustrated in FIG. 1A, may be initiated (block 223). The method may terminate at end block 225, for example.

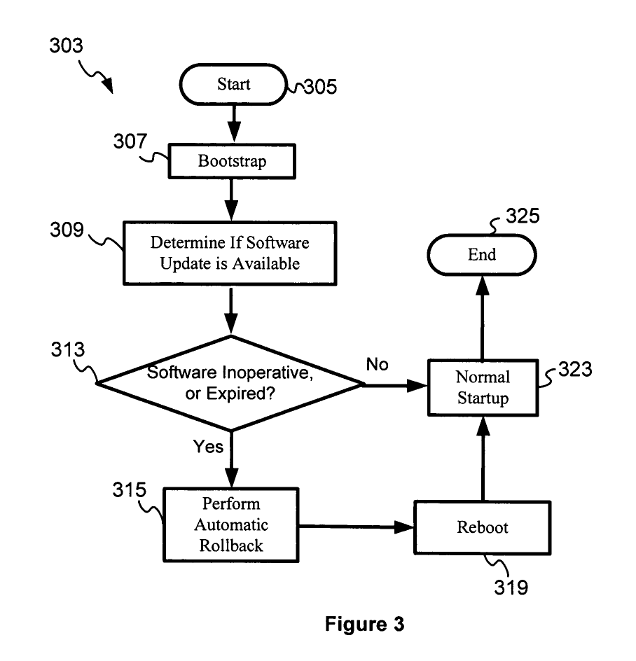

FIG. 3 is a flow diagram 303 illustrating a method of performing an automatic software rollback in a mobile electronic device, such as for example, mobile electronic device 107A illustrated in FIG. 1A, according to an embodiment of the present invention.

In an embodiment according to the present invention, the method may begin at start block 305, for example. In an embodiment according to the present invention, the mobile electronic device, such as for example, mobile electronic device 107A illustrated in FIG. 1A, may be powered up, for example, and a boot loader, such as for example boot loader 111A illustrated in FIG. 1A, may initiate bootstrap operations (block 307).

In an embodiment according to the present invention, a bootstrap code may be adapted to determine whether to update firmware/software (block 309) and whether an update is available. In an embodiment according to the present invention, the electronic device such as for example, mobile electronic device 107A illustrated in FIG. 1A, may proceed to a normal startup or perform a rollback of firmware/software based upon the previous determination (decision block 313).

In an embodiment according to the present invention, if it is determined that a firmware/software update is unnecessary/unavailable, normal startup may be invoked (block 323). In an embodiment according to the present invention, a determination may be made as to whether the updated firmware/software is inoperative or expired (block 313). In an embodiment according to the present invention, an automatic/autonomous rollback to an older/previous, un-updated version of the firmware/software may be self-initiated by the electronic device, such as for example, mobile electronic device 107A illustrated in FIG. 1A (block 315). In an embodiment according to the present invention, the mobile electronic device, such as for example, mobile electronic device 107A illustrated in FIG. 1A, may be rebooted after rollback has been performed, for example, (block 319).

In an embodiment according to the present invention, normal startup of the mobile electronic device, such as for example, mobile electronic device 107A illustrated in FIG. 1A, may be initiated (block 223). The method may terminate at end block 225, for example.

In an embodiment according to the present invention, if it is determined that the firmware/software is operative, and thus that the update is successfully completed, (block 313), then normal startup of the mobile electronic device, such as for example, mobile electronic device 107A illustrated in FIG. 1A, may be initiated (block 323). The method may terminate at end block 325, for example.

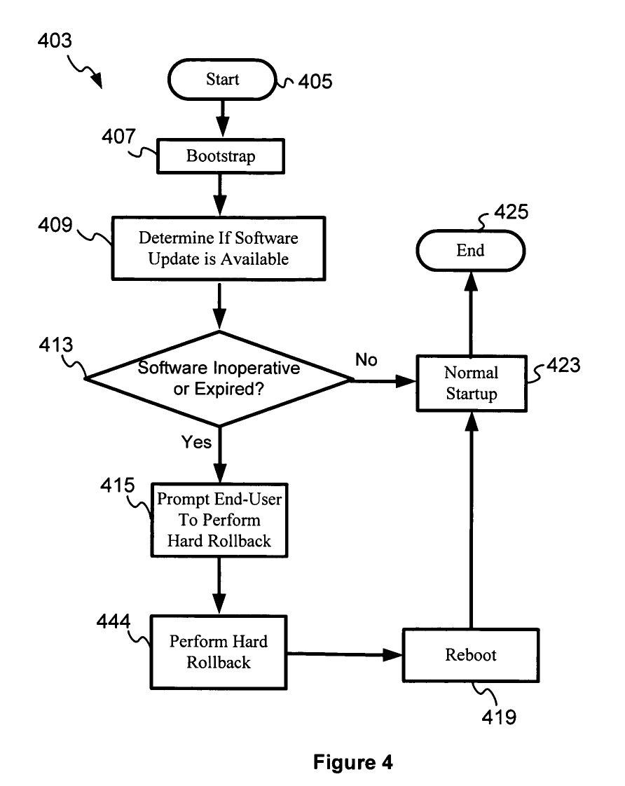

FIG. 4 is a flow diagram 403 illustrating a method of performing an hard software rollback in a mobile electronic device, such as for example, mobile electronic device 107A illustrated in FIG. 1A, according to an embodiment of the present invention.

In an embodiment according to the present invention, the method may begin at start block 405, for example. In an embodiment according to the present invention, the mobile electronic device, such as for example, mobile electronic device 107A illustrated in FIG. 1A, may be powered up, for example, and a boot loader, such as for example boot loader 111A illustrated in FIG. 1A, may initiate bootstrap operations (block 407).

In an embodiment according to the present invention, a bootstrap code may be adapted to determine whether to update firmware/software (block 409) and whether an update is available. In an embodiment according to the present invention, the electronic device, such as for example, mobile electronic device 107A illustrated in FIG. 1A, may proceed to a normal startup or perform a rollback of firmware/software based upon the previous determination (decision block 413).

In an embodiment according to the present invention, if it is determined that a firmware/software update is unnecessary/unavailable, normal startup may be invoked (block 423). In an embodiment according to the present invention, a determination may be made as to whether the updated firmware/software is inoperative or expired (block 413). In an embodiment according to the present invention, the mobile electronic device, such as for example, mobile electronic device 107A illustrated in FIG. 1A, may prompt the end-user to perform a hard rollback (block 415). The end-user may also be enabled to initiate a rollback without being prompted by the mobile electronic device, such as for example, upon dissatisfaction with a particular update service.

In an embodiment according to the present invention, a network device or a network administrator may transmit a message comprising a prompt for the end-user to perform a hard rollback (block 415). The network device or network administrator may also command the mobile electronic device to rollback to a previous version of firmware/software at the end of a limited trial period, for example, or upon determining that service fee is not paid.

In an embodiment according to the present invention, a hard rollback to an older/previous, un-updated version of the firmware/software may be initiated by an end-user of the electronic device, such as for example, mobile electronic device 107A illustrated in FIG. 1A (block 444). In an embodiment according to the present invention, the mobile electronic device, such as for example, mobile electronic device 107A illustrated in FIG. 1A, may be rebooted after the rollback, for example, (block 419).

In an embodiment according to the present invention, normal startup of the mobile electronic device, such as for example, mobile electronic device 107A illustrated in FIG. 1A, may be initiated (block 423). The method may terminate at end block 425, for example.

In an embodiment according to the present invention, if it is determined that the firmware/software is operative, and thus that the update is successfully completed, (block 413), then normal startup of the mobile electronic device such as for example, mobile electronic device 107A illustrated in FIG. 1A, may be initiated (block 423). The method may terminate at end block 425, for example.

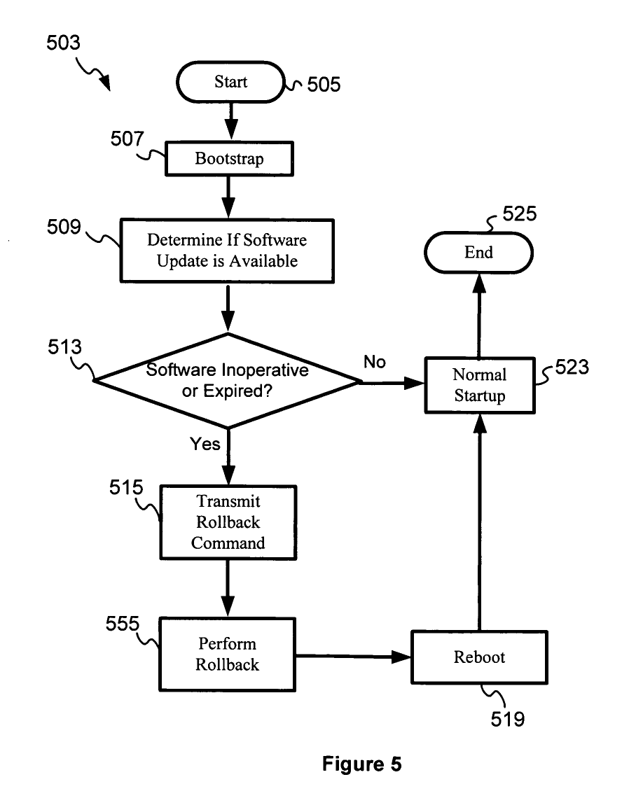

FIG. 5 is a flow diagram 503 illustrating a method of initiating a software rollback in a mobile electronic device, such as for example, mobile electronic device 107A illustrated in FIG. 1A, according to an embodiment of the present invention.

In an embodiment according to the present invention, the method may begin at start block 505, for example. In an embodiment according to the present invention, the mobile electronic device, such as for example, mobile electronic device 107A illustrated in FIG. 1A, may be powered up, for example, and a boot loader, such as for example boot loader 111A illustrated in FIG. 1A, may initiate bootstrap operations (block 507).

In an embodiment according to the present invention, a bootstrap code may be adapted to determine whether to update firmware/software (block 509) and whether an update is available, for example. In an embodiment according to the present invention, the electronic device, such as for example, mobile electronic device 107A illustrated in FIG. 1A, may proceed to a normal startup or perform a rollback of firmware/software based upon the previous determination (decision block 513).

In an embodiment according to the present invention, if it is determined that a firmware/software update is unnecessary/unavailable, normal startup may be invoked (block 523). In an embodiment according to the present invention, a determination may be made as to whether the updated firmware/software is inoperative or expired (block 513). In an embodiment according to the present invention, a network device or a network administrator may transmit a message comprising a prompt for the end-user to perform a hard rollback (block 515) upon determining that firmware/software in the mobile electronic device is inoperative, for example.

In an embodiment according to the present invention, a network device or a network administrator may transmit a command for the mobile electronic device, such as for example, mobile electronic device 107A illustrated in FIG. 1A, to initiate and perform an automatic/autonomous rollback (block 515) upon determining that a limited trial period has expired or that a service fee has not been paid, for example.

In an embodiment according to the present invention, a hard rollback to an older/previous, un-updated version of the firmware/software may be initiated by an end-user of the electronic device, such as for example, mobile electronic device 107A illustrated in FIG. 1A, or an automatic rollback may be initiated and performed autonomously by the mobile electronic device (block 555). In an embodiment according to the present invention, the mobile electronic device, such as for example, mobile electronic device 107A illustrated in FIG. 1A, may be rebooted after the rollback, for example, (block 519).

In an embodiment according to the present invention, normal startup of the mobile electronic device, such as for example, the mobile electronic device 107A illustrated in FIG. 1A, may be initiated (block 523). The method may terminate at end block 525, for example.

In an embodiment according to the present invention, if it is determined that the firmware/software is operative, and thus that the update is successfully completed, (block 513), then normal startup of the mobile electronic device, such as for example, the mobile electronic device 107A illustrated in FIG. 1A, may be initiated (block 523). The method may terminate at end block 525, for example.

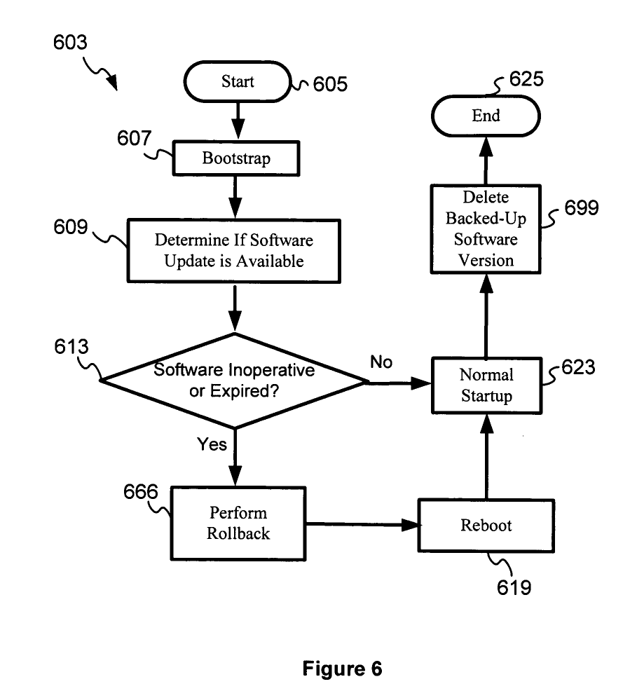

FIG. 6 is a flow diagram 603 illustrating a method of deleting backed up firmware/software after performing a software rollback in a mobile electronic device, such as for example, the mobile electronic device 107A illustrated in FIG. 1A, according to an embodiment of the present invention.

In an embodiment according to the present invention, the method may begin at start block 605, for example. In an embodiment according to the present invention, the mobile electronic device, such as for example, the mobile electronic device 107A illustrated in FIG. 1A, may be powered up, for example, and a boot loader, such as, for example, the boot loader 111A illustrated in FIG. 1A, may initiate bootstrap operations (block 607).

In an embodiment according to the present invention, a bootstrap code may be adapted to determine whether to update firmware/software (block 609) and whether an update is available. In an embodiment according to the present invention, the electronic device, such as for example, the mobile electronic device 107A illustrated in FIG. 1A, may proceed to a normal startup or perform a rollback of firmware/software based upon the previous determination (decision block 613).

In an embodiment according to the present invention, if it is determined that a firmware/software update is unnecessary/unavailable, normal startup may be invoked (block 623). In an embodiment according to the present invention, a determination may be made as to whether the updated firmware/software is inoperative or expired (block 613). In an embodiment according to the present invention, an automatic/autonomous rollback to an older/previous, un-updated version of the firmware/software may be self-initiated by the electronic device, such as for example, the mobile electronic device 107A illustrated in FIG. 1A (block 615 there is no block 615).

In an embodiment according to the present invention, a hard rollback to an older/previous, un-updated version of the firmware/software may be initiated by an end-user of the electronic device, such as for example, the mobile electronic device 107A illustrated in FIG. 1A (block 666). In an embodiment according to the present invention, the mobile electronic device, such as for example, the mobile electronic device 107A illustrated in FIG. 1A, may be rebooted after the rollback, for example, (block 619).

In an embodiment according to the present invention, normal startup of the mobile electronic device, such as for example, the mobile electronic device 107A illustrated in FIG. 1A, may be initiated (block 623). In an embodiment according to the present invention, the backed up software stored in the back up zone, for example, the backup zone 133A illustrated in FIG. 1A, may be deleted, erased, or overwritten freeing up the memory for other electronic device tasks (block 699), for example. The method may terminate at end block 625, for example.

In an embodiment according to the present invention, if it is determined that the firmware/software is operative, and thus that the update is successfully completed, (block 613), then normal startup of the mobile electronic device, such as for example, mobile electronic device 107A illustrated in FIG. 1A, may be initiated (block 623).

In an embodiment according to the present invention, the backed up software stored in the back up zone, for example, the backup zone 133A illustrated in FIG. 1A, may be deleted, erased, or overwritten freeing up the memory for other electronic device tasks (block 699), for example. The method may terminate at end block 625, for example.

Accordingly, the present invention may be realized in hardware, software, firmware and/or a combination thereof. The present invention may be realized in a centralized fashion in at least one computer system, or in a distributed fashion where different elements are spread across several interconnected computer systems. Any kind of computer system or other apparatus adapted for carrying out the methods described herein may be suitable. A typical combination of hardware and firmware/software may be a general-purpose computer system with a computer program that, when being loaded and executed, controls the computer system to carry out the methods described herein.

The present invention may also be embedded in a computer program product comprising all of the features enabling implementation of the methods described herein, which when loaded in a computer system is adapted to carry out these methods. Computer program in the present context means any expression, in any language, code or notation, of a set of instructions intended to cause a system having information processing capability to perform a particular function either directly or after either or both of the following: a) conversion to another language, code or notation; and b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A method of updating a mobile electronic device, the method comprising:
storing a copy of one of firmware and software to be updated in the mobile electronic device;
updating the one of firmware and software;
determining whether the update was successful; and
rolling back to the stored copy of the one of firmware and software upon determining that the update was unsuccessful.

2. The method according to claim 1, further comprising commencing normal operation upon determining that the update was successful.

3. The method according to claim 1, further comprising deleting the stored copy of one of firmware and software upon determining that the update was successful.

4. The method according to claim 1, further comprising transmitting a rollback command to the mobile electronic device.

5. The method according to claim 1, further comprising:
receiving a rollback command by the mobile electronic device; and
performing an autonomous, automatic rollback to the stored copy of the one of firmware and software.

6. The method according to claim 1, further comprising:
receiving a rollback command by the mobile electronic device; and
prompting an end-user to initiate rollback to the stored copy of the one of firmware and software.

7. The method according to claim 1, further comprising prompting an end-user to initiate rollback to the stored copy of the one of firmware and software.

8. The method according to claim 1, wherein determining whether the update was successful is performed by one of the mobile electronic device and an associated mobile electronic device network component.

9. The method according to claim 1, wherein updating the one of firmware and software comprises executing at least one program instruction for converting a first version of the one of firmware and software to a second version of the one of firmware and software.

10. The method according to claim 1, wherein storing a copy of one of firmware and software to be updated comprises writing an un-updated version of the one of firmware and software to one of a non-volatile memory component, a NAND-type flash memory component, a NOR-type flash memory component, and a combination NAND/NOR-type flash memory component.

11. A mobile electronic device adapted to rollback to an un-updated version of one of firmware and software after an update thereof, the mobile electronic device comprising:
updating software adapted to perform an update upon the one of firmware and software;
an update comprising at least one executable program instruction for converting a first version of the one of firmware and software to a second version of the one of firmware and software; and
a memory location adapted to store the un-updated version of the one of firmware and software to be updated at least until the update is completed, wherein upon determining that the update was unsuccessful, the mobile electronic device is adapted to reinstall and employ the un-updated version of the one of firmware and software.

12. The mobile electronic device according to claim 11, wherein the memory location adapted to store the un-updated version of the one of firmware and software to be updated comprises one of a non-volatile memory component, a NAND-type flash memory component, a NOR-type flash memory component, and a combination NAND/NOR-type flash memory component.

13. The mobile electronic device according to claim 11, further comprising software adapted to manage memory resources in the mobile electronic device.

14. The mobile electronic device according to claim 11, wherein the mobile electronic device is adapted to commence normal operation upon determining that the update was successful.

15. The mobile electronic device according to claim 11, wherein the mobile electronic device is adapted to delete the un-updated version of one of firmware and software upon determining that the update was successful.

16. The mobile electronic device according to claim 11, wherein the mobile electronic device is adapted to prompt an end-user to initiate rollback to the un-updated version of the one of firmware and software.

17. The mobile electronic device according to claim 11, wherein the mobile electronic device is adapted to receive a rollback command and perform an autonomous, automatic rollback to the un-updated version of the one of firmware and software.

18. The mobile electronic device according to claim 11, wherein the mobile electronic device is adapted to receive a rollback command and prompt an end-user to initiate rollback to the un-updated version of the one of firmware and software.

19. The mobile electronic device according to claim 11, wherein the mobile electronic device is adapted to perform an autonomous, automatic rollback to the un-updated version of the one of firmware and software.

20. The mobile electronic device according to claim 11, further comprises software adapted to determine whether the update was performed successfully.

21. A method of updating a mobile electronic device, the method comprising:
storing a copy of one of firmware and software to be updated in the mobile electronic device, wherein the one of firmware and software and the stored copy are compressed;
decompressing the one of firmware and software;
updating the one of firmware and software;
re-compressing the updated one of firmware and software;
rebooting the mobile electronic device; and
executing the updated one of firmware and software, wherein the mobile electronic device is adapted to rollback to the stored copy of the one of firmware and software.

22. The method according to claim 21, further comprising rolling back to the stored copy of the one of firmware and software upon determining that the update was unsuccessful.

23. The method according to claim 21, further comprising rolling back to the stored copy of the one of firmware and software upon determining that a limited-time trial period has expired.

24. The method according to claim 21, further comprising rolling back to the stored copy of the one of firmware and software upon determining that service fees are not paid.

25. The method according to claim 21, further comprising enabling an end-user to rollback to the stored copy of the one of firmware and software when dissatisfied with updated services provided by the updated one of firmware and software.

26. The method according to claim 21, further comprising enabling one of a network component and a network administrator to command the mobile electronic device to rollback to the stored copy of the one of firmware and software by transmitting a rollback command to the mobile electronic device.

27. The method according to claim 21, wherein updating the one of firmware and software comprises executing at least one program instruction for converting a first version of the one of firmware and software to a second version of the one of firmware and software.

28. The method according to claim 1, wherein storing a copy of one of firmware and software to be updated comprises writing a compressed, un-updated version of the one of firmware and software to one of a non-volatile memory component, a NAND-type flash memory component, a NOR-type flash memory component, and a combination NAND/NOR-type flash memory component.
